(19) United States
(12) Patent Application Publication
(10) Pub. No.: US 2008/0066104 A1
(43) Pub. Date: Mar. 13, 2008

(54) Program providing method, program for program providing method, recording medium which records program for program providing method and program providing apparatus

(76) Inventor: Sho Murakoshi, Tokyo (JP)

Correspondence Address: William S. Frommer, Esq.;FROMMER LAWRENCE & HAUG LLP, 745 Fifth Avenue, New York, NY, 10151, US

(21) Appl. No.: 11/893,905

(22) Filed: Aug. 17, 2007

(30) Foreign Application Priority Data
Aug. 21, 2006 (JP) 2006-223752

(51) Int. Cl. G06F 3/00; H04N 5/222

(52) U.S. Cl. 725/39; 348/722; 725/44

(57) ABSTRACT

A program providing method recording a program by video data and audio data in a recording medium and providing the program to a user, including the steps of detecting digest sections representing the contents of the program by video data by analyzing pictures of the video data, detecting keywords whose appearance frequency is high from captions of the program, creating indexes of the program by detecting parts where appearance frequency of the keywords detected in the step of detecting keywords is high from captions of the digest sections, and displaying the indexes.

### CROSS REFERENCE TO RELATED APPLICATIONS

The present invention contains subject matter related to Japanese Patent Application JP 2006-223752 filed in the Japanese Patent Office on Aug. 21, 2006, the entire contents of which being incorporated herein by reference.

### BACKGROUND OF THE INVENTION

1. Field of the Invention

The invention relates to a program providing method, a program for a program providing method, a recording medium which records a program for a program providing method and a program providing apparatus, which can be applied to, for example, a recording/playback apparatus playing back a program desired by a user from programs recorded in a recording medium having large capacity. In an embodiment of the invention, digest sections representing the contents of a program are detected by analyzing pictures and parts of captions in the digest sections including keywords having high appearance frequency detected in the whole captions are set as indexes, thereby grasping the summary of the program accurately and precisely.

2. Description of the Related Art

In related arts, a recording/playback apparatus such as a hard disc recorder records programs provided by television broadcasting and is used when the programs are viewed again later. Such recording/playback apparatus is capable of recording many programs by the increase of recording capacity in recent years. Accordingly, in recent years, methods of enhancing the convenience of users in selecting programs by creating thumbnail images for introducing the program contents in the recording/playback apparatus are proposed.

Concerning the above, in JP-A-11-184867, a method of playing back a program according to indexes by using speeches in the program provided by closed captions is proposed.

In this kind of recording/playback apparatus, if the summary of the program is grasped without viewing the detail of the program recorded and stored, for example, news of interest can be selectively viewed among many news recorded and stored, as a result, it is conceivable that usability of this kind of recording/playback apparatus can be further improved.

However, in the introduction of programs by thumbnail images in related arts, there is a problem that it is difficult to obtain the summary of the program accurately and precisely.

### SUMMARY OF THE INVENTION

It is desirable to propose a program providing method, a program for a program providing method, a recording medium which records a program for a program providing method and a program providing apparatus which are capable of grasping a summary of the program accurately and precisely.

According to an embodiment of the invention, there is provided a program providing method recording a program by video data and audio data in a recording medium and providing the program to a user, including the steps of detecting digest sections representing the contents of the program by video data by analyzing pictures of the video data, detecting keywords whose appearance frequency is high from captions of the program, creating indexes of the program by detecting parts where appearance frequency of the keywords detected in the step of detecting keywords is high from captions of the digest sections and displaying the indexes.

Also according to an embodiment of the invention, there is provided a program for a program providing method recording a program by video data and audio data in a recording medium and providing the program to a user, including the steps of detecting digest sections representing the contents of the program by video data by analyzing pictures of the video data, detecting keywords whose appearance frequency is high from captions of the program, creating indexes of the program by detecting parts where appearance frequency of the keywords detected in the step of detecting keywords is high from captions of the digest sections and displaying the indexes.

Also according to an embodiment of the invention, there is provided a recording medium which records a program for a program providing method recording a program by video data and audio data in a recording medium and providing the program to a user, the program providing method includes the steps of detecting digest sections representing the contents of the program by video data by analyzing pictures of the video data, detecting keywords whose appearance frequency is high from captions of the program, creating indexes of the program by detecting parts where appearance frequency of the keywords detected in the step of detecting keywords is high from captions of the digest sections and displaying the indexes.

Also according to an embodiment of the invention, there is provided a program providing apparatus recording a program by video data and audio data in a recording medium and providing the program to a user, including a digest section detection unit detecting digest sections representing the contents of the program by video data by analyzing pictures of the video data, a keyword detection unit detecting keywords whose appearance frequency is high from captions of the program, an index creation unit creating indexes of the program by detecting parts where appearance frequency of the keywords detected in the keyword detection unit is high from captions of the digest sections and an index display unit displaying the indexes.

According to the configuration of the embodiment of the invention, it is predictable that captions representing the contents of the program are allocated in digest sections. Therefore, when keywords appearance frequency of which is high are detected from the captions and parts where appearance frequency of the keywords is high are detected from captions of the digest sections, indexes can be created so as to introduce a summary of the program accurately and so as to grasp the summary of the program precisely, as a result, the summary of the program can be grasped accurately by the display of the indexes.

### BRIEF DESCRIPTION OF THE DRAWINGS

FIG. 1 is a flowchart showing a processing procedure a central processing unit in a hard disc recorder according to Embodiment 1 of the invention;

FIG. 2 is a block diagram showing the hard disc recorder of Embodiment 1 of the invention;

FIG. 3 is a function block diagram of the hard disc recorder of FIG. 2;

FIG. 4 is a flowchart showing a processing procedure of the central processing unit at the time of recording in the hard disc recorder of FIG. 2;

FIG. 5 is a schematic diagram for explaining digests;

FIG. 6 is a flowchart showing digest section determination processing in the processing procedure of FIG. 1:

FIG. 7 is a flowchart showing caption sorting processing in the processing procedure of FIG. 1;

FIG. 8 is a flowchart showing important keyword extraction processing in the processing procedure of FIG. 1;

FIG. 9 is a chart for explaining an example of extracting important keywords;

FIG. 10 is a chart showing determination of respective keywords;

FIG. 11 is a flowchart showing index generating processing in the processing procedure of FIG. 1;

FIG. 12 is a chart for explaining a processing procedure of FIG. 11;

FIG. 13 is a plan view showing a display example of indexes; and

FIG. 14 is a plan view showing another display example of indexes.

### DESCRIPTION OF THE PREFERRED EMBODIMENTS

Hereinafter, an embodiment of the invention will be described in detail with reference to the drawings appropriately.

### Embodiment 1

### (1) Configuration of Embodiment 1

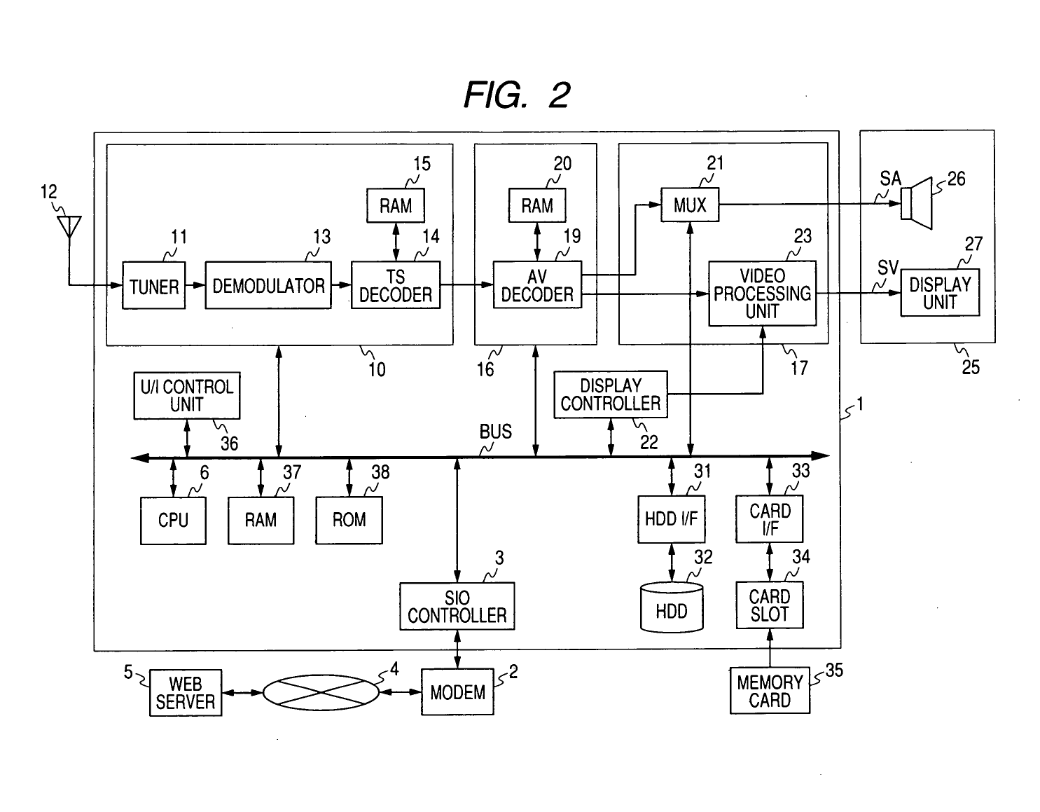

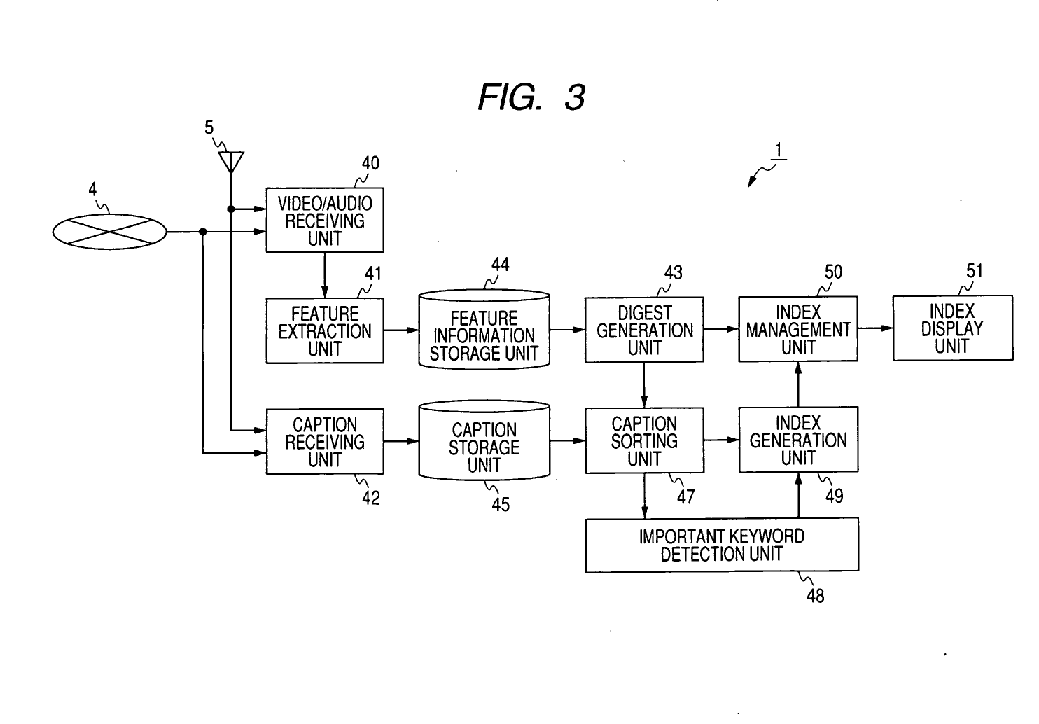

FIG. 2 is a block diagram showing a configuration of a hard disc recorder according to Embodiment 1 of the invention, and FIG. 3 is a function block diagram of a relevant part thereof. A hard disc recorder 1 records programs provided by television broadcasting and programs provided by internet and provides them to users.

In the hard disc recorder 1, a modem 2 obtains a transport stream of a video content from a Web server 5 provided on an internet 4 by control of a SIO (Serial I/O) controller 3 and outputs it to the SIO controller 3. The SIO controller 3 controls operation of the modem 2 by control of a CPU: Central Processing Unit 6, and outputs the transport stream outputted from the modem 2 to a BUS. According to the configuration of the modem 2 and the SIO controller 3, the hard disc recorder 1 receives programs provided by the internet.

A broadcast receiving unit 10 receives a video content by television broadcasting by control of the central processing unit 6, outputting video data and audio data.

In the broadcast receiving unit 10, a tuner 11 selects and receives broadcast wave desired by a user from various broadcast waves received by an antenna 12, and outputs an immediate frequency signal according to the received result. A demodulator 13 processes the intermediate frequency signal outputted from the tuner 11 and output a transport stream. A TS decoder 14 temporality stores the transport stream outputted from the demodulator 13 or the transport stream inputted from the SIO controller 3 through the BUS in a RAM (Random Access Memory) 15 and processed it to play back video data, audio data and teletext broadcasting data. The TS decoder 14 outputs the played video data and audio data to a decoding unit 16 for monitoring or for creating digests described later. The TS decoder 14 also outputs played video data, audio data and teletext broadcasting data to the BUS for recording the video content.

Accordingly, in the hard disk recorder 1 (FIG. 3), the broadcast receiving unit 10 and the SIO controller 3 configure a video/audio receiving unit 40 which receives video contents by television broadcasting and video contents by internet. The broadcast receiving unit 10 and the SIO controller 3 also form a caption receiving unit 42 which receives captions by teletext broadcasting data of video contents by television broadcasting and video contents by internet.

The decoding unit 16 decompresses video data and audio data outputted from the BUS or video data and audio data outputted from the broadcast receiving unit 10 by control of the central processing unit 6. The decoding unit 16 also outputs the decompressed video data and audio data to an output unit 17 for monitoring, and outputs them to the BUS for creating digests described later.

The output unit 17 mixes video data and audio data for monitoring outputted from the decoding unit 16 with video data and audio data relating to various information to be provided to the user and outputs the data by control of the central processing unit 6.

In the output unit 17, a mixer (MUX) 21 mixes audio data outputted from the decoding unit 16 with audio data outputted from the BUS and outputs the data, accordingly, superimposes various alarm tones and the like on audio of the played result, namely, audio of the video content for monitoring and outputs the audio data. The display controller 22 generates video data for OSD (On Screen Display) relating to menus and the like by video data outputted from the BUS and outputs the data. A video processing unit 23 mixes video data outputted from the decoding unit 16 with video data outputted from the display controller 22 and outputs the data, accordingly, superimposes various icons and the like on video of the played result, namely, video of the video content for monitoring.

The hard disc recorder 1 outputs video data and audio data outputted from the output unit 17 to a monitoring device 25, then, audio and video of these audio data and video data are provided to a user by a speaker 26 and a display device 27 provided at the monitoring device 25.

A hard disc interface (hard disc I/F) 31 outputs video data, audio data, teletext broadcasting data and the like outputted to the BUS to a hard disc drive (HDD) 32 by control of the central processing unit 6, accordingly, these data is recorded in the hard disc drive 32. Also, data stored in the hard disc drive 32 is played back and outputted to the BUS by similar control of the central processing unit 6.

A card interface (card I/F) 33 is an interface between a memory card 35 mounted in a card slot 34 and the BUS, recording various data outputted to the BUS in the memory card 35 by control of the central processing unit 6 and outputting various data recorded in the memory card 35 to the BUS 35.

An U/I control unit 36 receives a remote control signal from a remote commander and notifies it to the central processing unit 6.

The central processing unit 6 is a controller which controls operations of the hard disk recorder 1, controlling operations of respective units by securing a work area in a RAM 37 and executing programs recorded in a ROM (Read Only Memory) 38. In the embodiment, programs of the central processing unit 6 are provided by being previously installed in the hard disc recorder 1, however, instead of that, it is also preferable that programs are provided by being recorded in various recording media such as an optical disc, a magnetic disc, a memory card and the like, and further, it is preferable that programs are provided by being downloaded through networks such as internet.

According to the execution of the program, when a user instructs recording of a video content, the central processing unit 6 receives television broadcast instructed by the user by a broadcast receiving unit 10, and records video data, audio data and teletext broadcasting data outputted from the TS decoder 14 in the hard disk drive 32. The central processing unit 6 also accesses the Web server 5 instructed by the user to obtain a video content, and after playing back video data, audio data and teletext broadcasting data of the obtained video content by the TS decoder 14, records the data in the hard disk drive 32.

When the user instructs monitoring of a video content, the central processing unit 6, after processing video data and audio data played back by the TS decoder 14 in the decoding unit 16, outputs the data from the output unit 17 to the monitoring device 25. When the user instructs playback of a video content recorded in the hard disc drive 32, the central processing unit 6, after playing back corresponding video data and audio data from the hard disk drive 32 and decoding the data in the decoding unit 16, outputs the data from the output unit 17 to the monitoring device 25.

At the time of recording a video content, the central processing unit 6 decodes video data to be recorded in the hard disc drive 32 in the decoding unit 16 and obtains the data, then, analyzes the obtained video data. The central processing unit 6 also processes the analyzed result using available time after completing the recording, and sets digest sections, then, sets indexes to the digest sections by analyzing the teletext broadcasting data. Also, at the time of playing back the video content according to the instruction of the user, the indexes are displayed to execute index processing. The digest section means a section in the video, which representing the content of the program.

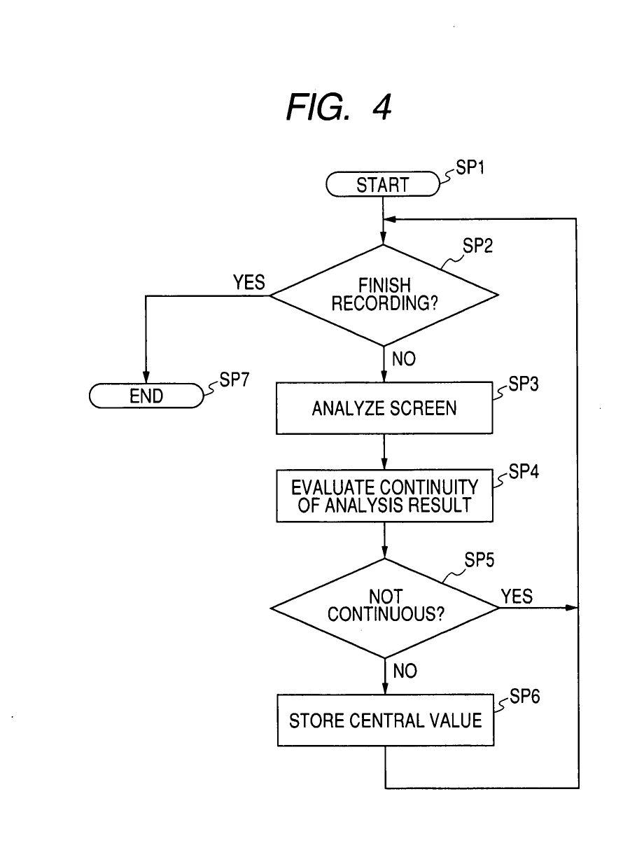

FIG. 4 is a flowchart showing a processing procedure of the central processing unit 6 at the time of recording. When recording is started, the central processing unit 6 starts the processing procedure, proceeding from Step SP1 to Step SP2. The central processing unit 6 judges whether completion of recording was instructed or not, and when a negative result is obtained, proceeds from Step SP2 to Step SP3.

In Step SP3, the central processing unit 6 analyzes video data outputted from the decoding unit 16, and in subsequent Step SP4, processes the analyzed result to calculate an evaluation value which evaluates continuity of a screen. For example, the central processing unit 6 divides the screen into plural regions and calculates motions vectors in respective regions to calculate the evaluation value. The plural motion vectors detected in this manner vary when a scene is changed, whereas they show almost the same values when taking pictures of the same object at the same camerawork. Therefore, the evaluation value shows continuity of pictures in continuous frames.

Accordingly, in the subsequent Step SP5, the central processing unit 6 compares the calculated evaluation value with an evaluation value found in a frame just before to judge presence/absence of continuity with respect to the picture just before, and when there is continuity, the process returns to Step SP2. On the other hand, when there is not continuity, the process proceeds to Step SP6, the central processing unit 6 records the evaluation value calculated in Step SP3 and returns to Step SP2.

The central processing unit 6 repeats the processing procedure of Step SP2-SP3-SP4-SP5-SP6-SP2 by each certain frame of video data decoded in the decoding unit 16. In the repeat by each certain frame, when there is not continuity, an evaluation value is recorded as a feature amount, and when the recording is finished, the process proceeds from Step SP2 to SP7 to end the processing procedure. Accordingly, the central processing unit 6 forms a feature extraction unit 41 (FIG. 3) which extracts the feature amount.

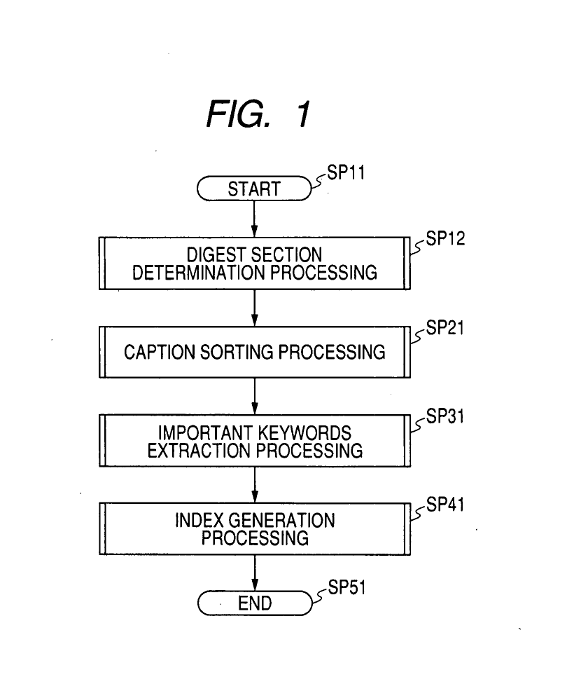

FIG. 1 is a flowchart showing a processing procedure of the feature amount detected as described above. The central processing unit 6 executes the processing procedure in an available time after finishing the recording. In the case that processing ability of the central processing unit 6 is sufficient, it is also preferable that the processing procedure of FIG. 1 is executed during recording.

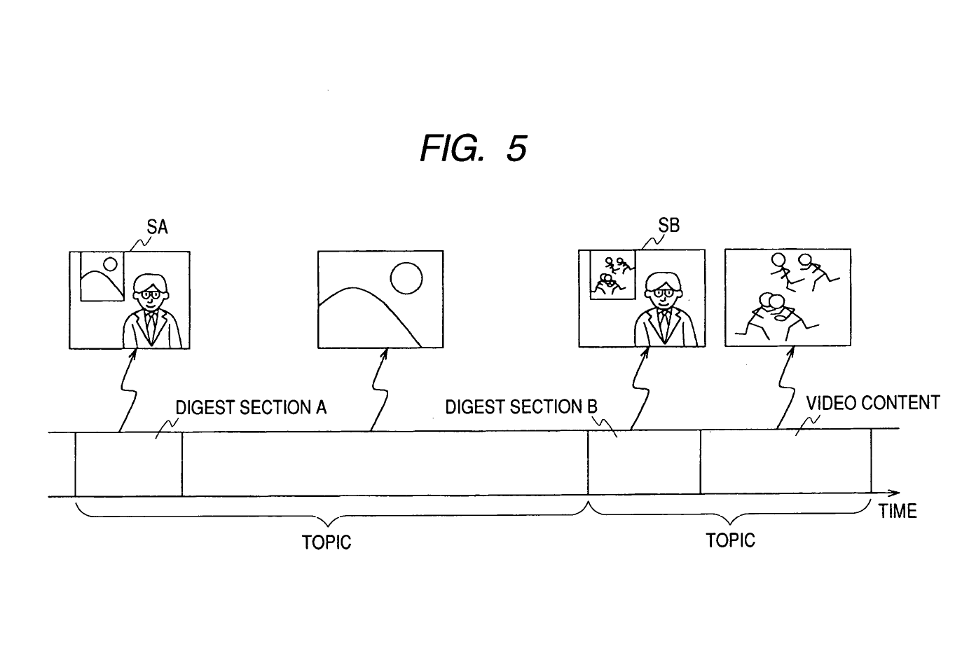

In the processing procedure, the central processing unit 6 proceeds from Step SP11 to Step SP12, executing digest section determination processing. The digest section determination processing is processing in which a video content is divided into digest sections A, B and other sections as shown in FIG. 5.

The digest section means a part of the video content, which represents the video content, and for example, when the video content is a news program as shown in FIG. 5, scenes SA, SB in which an announcer introduces summaries of news at the beginning of each piece of news correspond to digest sections. Hereinafter, a section from a digest section A to the top of a digest section B is called as a topic. In the news program, sections in which digest sections are excluded from the topic sections will be sections in which specific news videos TA, TB are broadcasted.

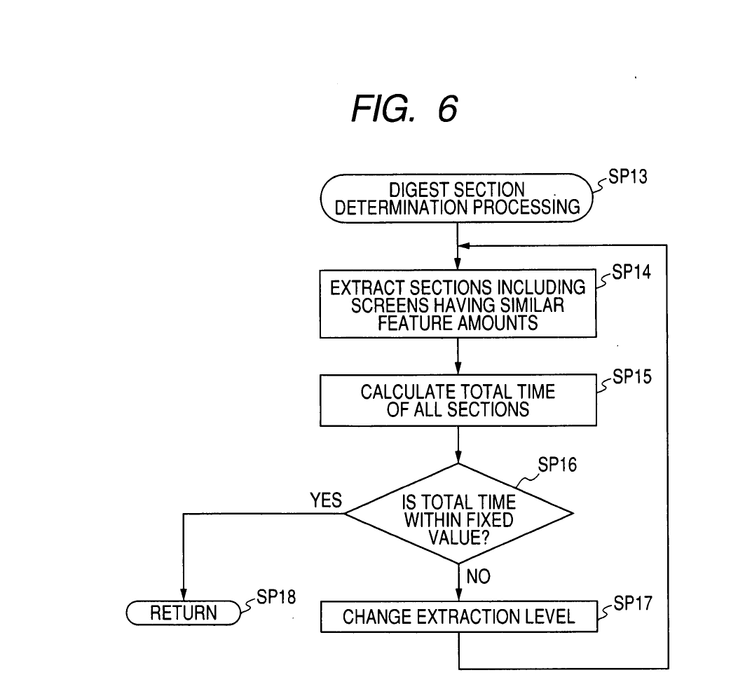

FIG. 6 is a flowchart showing the digest section determination processing in detail. The central processing unit 6, when starting the processing procedure, proceeds from Step SP13 to Step SP14. The central processing unit 6 detects a feature amount having largest distribution from recorded and stored distributions of feature amounts. The central processing unit 6 also sets a threshold value based on the detected feature amount, and determines the recorded and stored feature amounts by using the threshold value. Accordingly, the central processing unit 6 detects sections feature amounts of which are similar from the recorded video content.

The hard disk recorder 1 is capable of setting a period of time of a digest section to 5 stages of “short”, “shorter”, “normal”, “longer” and “long” by previous setting, and the central processing unit 6 executes the processing procedure of Step SP16 by setting the threshold value according to the setting by user in advance.

Subsequently, the central processing unit 6 proceeds to Step SP15. The central processing unit 6 calculates the total playback time of sections detected in the Step SP14. Also in subsequent Step SP16, the central processing unit 6 judges whether the playback time is within a certain value or not.

When a negative result is obtained here, the central processing unit 6 proceeds from Step SP16 to Step SP17, changing the threshold value used for determination of sections in Step SP14 to a side of a feature amount having largest distribution. The central processing unit 6 also returns to Step SP14 and determinates the recorded and stored feature amount by using the changed threshold value. Accordingly, the central processing unit 6 detects sections feature amounts of which are similar from the recorded video content again.

On the other hand, an affirmative result is obtained in Step SP16, the central processing unit 6, after setting sections detected in Step SP15 just before as digest sections, proceeds from Step SP16 to Step SP18 to end the processing procedure.

The central processing unit 6 forms a digest generation unit 43 (FIG. 3) setting digest sections by executing the processing procedure of FIG. 6. The hard disk drive 32 forms a feature information storage unit 44 recording feature amounts and also forms a caption storage unit 45 storing caption information by teletext broadcasting data. The method of detecting digest sections is not limited to the case by the processing of feature amounts shown in FIG. 6 but also various methods can be applied.

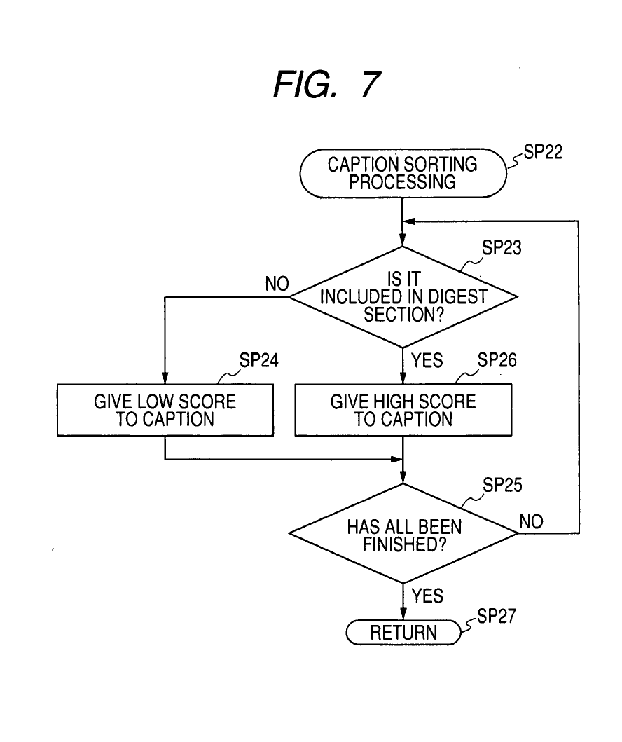

Subsequently, the central processing unit 6 proceeds to Step SP21 (FIG. 1), executing caption sorting processing. The caption sorting processing is processing in which captions provided by teletext broadcasting data are sorted into captions in the digest section and captions other than the digest section. In the embodiment, captions are sorted into the digest section and the section other than the digest section by allowing scores to be different in captions in the digest section and in captions in the section other than the digest section by execution of processing procedure shown in FIG. 7.

The central processing unit 6, when starting the processing procedure, proceeds from Step SP22 to Step SP23, selecting one sentence from captions provided by teletext broadcasting data, and judges whether the selected sentence is included in the digest section or not. When a negative result is obtained here, the central processing unit 6 proceeds to Step SP24, sets a low score to the caption of the sentence and proceeds to Step SP25. On the other hand, when an affirmative result is obtained here, the central processing unit 6 proceeds from Step SP23 to SP26, sets a high store to the caption of the sentence, and then, proceeds to Step SP25.

In the embodiment, the central processing unit 6 sets scores so that, as a rate of the digest section occupied in the whole topic decreases, a score of captions in the digest section increases as compared with a score of captions in the section other than the digest section. Accordingly, even when the length of the digest section and the length of the section other than the digest section change variously, important keywords can be appropriately detected without omission in important keyword extraction processing which will be described later.

More specifically, the central processing unit 6 sets a score of captions in a section other than the digest section to 1-point, and sets a value in which the number of characters of captions in the section other than the digest section which forms one topic is divided by the number of characters of corresponding captions in the digest section as a score of captions in digest section.

The central processing unit 6, in the subsequent step SP25, judges whether the processing procedure has been performed with respect to all sentences in the captions or not. When a negative result is obtained here, the central processing unit 6 returns from Step SP25 to Step SP23, performs processing of a subsequent sentence. On the other hand, when an affirmative result is obtained here, the central processing unit 6 proceeds from Step SP25 and Step SP27, completing the processing procedure.

According to the processing of FIG. 7, the central processing unit 6 forms a caption sorting unit 47 (FIG. 3) sorting captions provided by the text broadcasting data into captions in the digest section and captions in the section other than the digest section.

Subsequently, the central processing unit 6 returns to Step SP31 (FIG. 1), executing important keyword extraction processing. Here, important keyword extraction processing is processing of extracting important keywords indicating the content of a topic in each topic. The central processing unit 6 sets scores to respective keywords forming the caption, so that a keyword whose appearance frequency is high, and a keyword belonging to the digest section will have a higher score, and extracts keywords having higher scores.

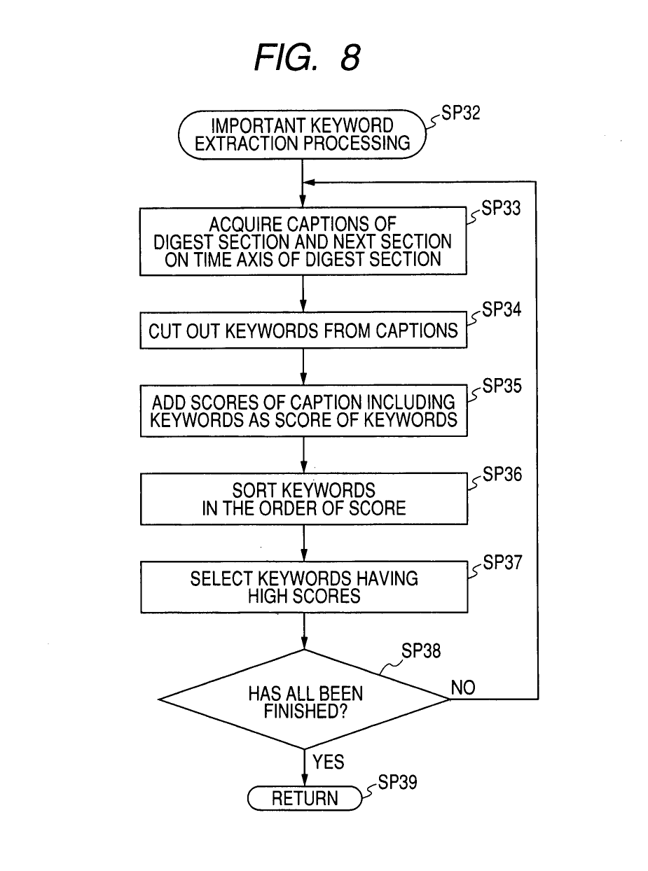

FIG. 8 is a flowchart showing important keyword extraction processing. The central processing unit 6, when starting the processing, proceeds from Step SP32 to Step SP33. The central processing unit 6 selects one topic from captions provided by the teletext broadcasting data and obtained captions of the selected topic. In the subsequent Step SP34, the central processing unit 6 cuts out keywords from the obtained captions. It should be noted that a method such as morphological analysis and the like can be applied for the cut-out of keyword.

Subsequently, the central processing unit 6 proceeds to Step SP35, calculating scores of respective keywords by adding scores set to captions in Step SP21 according to keywords.

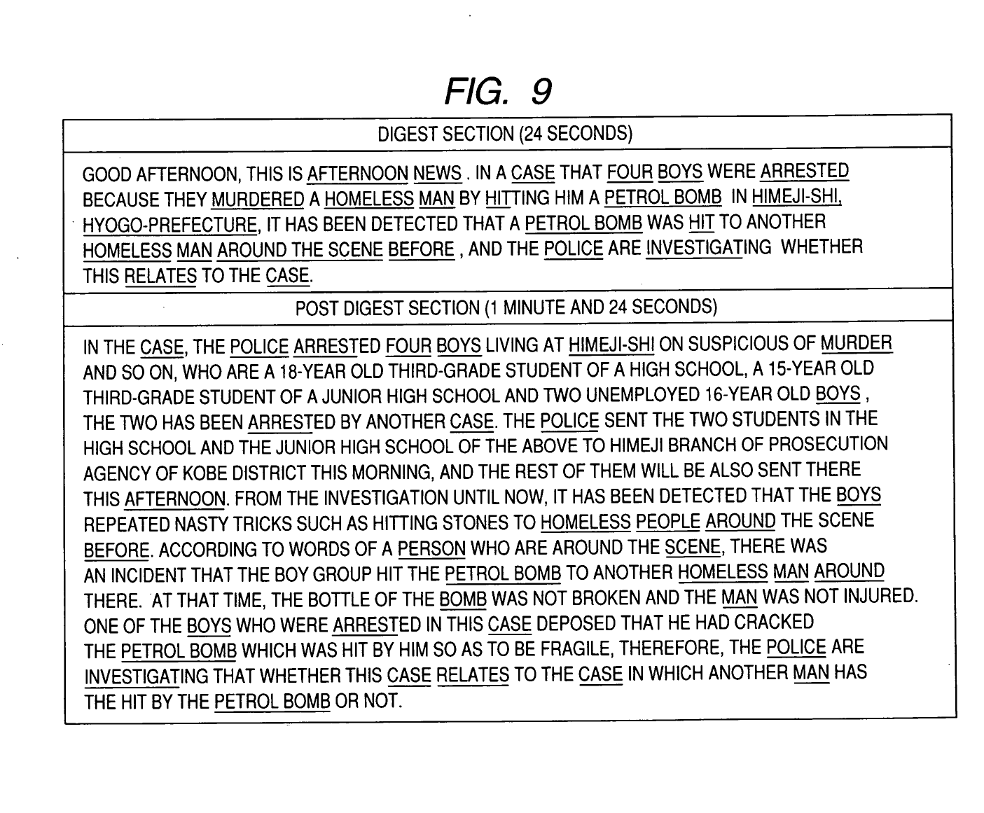

Here, as shown in FIG. 9, assume that a digest section for 24 seconds and a subsequent section for 1 minute and 24 seconds (hereinafter, referred to as a post-digest section) form captions of one topic. Also assume that keywords shown by being underlined were detected by the morphological analysis. In the example of FIG. 9, the number of characters of the digest section is 283 and the number of characters of the post-digest section is 981, therefore, a score of 3.4 points is set to captions of the digest section according to the processing of Step Sp21.

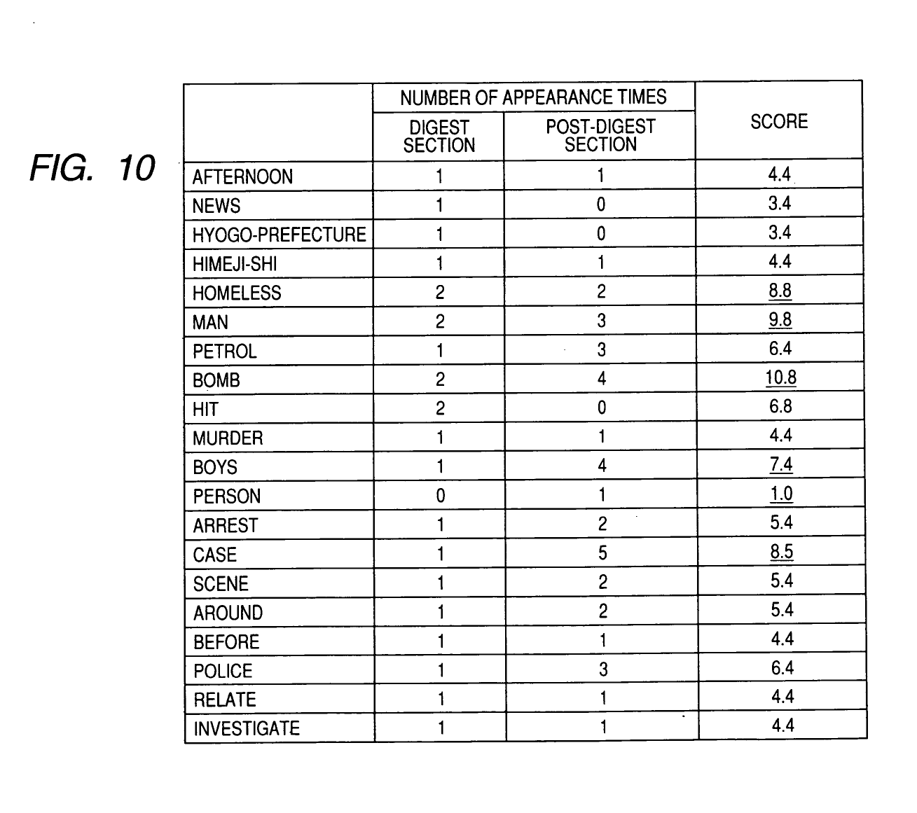

In this case, as shown in FIG. 10, the central processing unit 6 sets scores to respective keywords by the number of times respective keywords are detected in the digest section and the post-digest section respectively. In the example of FIG. 9 and FIG. 10, a keyword “afternoon” is detected once in the digest section, and once in the post-digest section, therefore, it is set as a score of 4.4 points (3.4 points+1 point). A keyword “news” is detected only once in the digest section, therefore, it is set as a score of 3.4 points.

Subsequently, the central processing unit 6 proceeds to Step SP36, sorts keywords in the order of score, selects a certain number of keywords in the order of score and sets them as important keywords. Therefore, in the example of FIG. 10, keywords “bomb”, “man”, “homeless”, “case” and “boys” are detected as important keywords.

Next, the central processing unit 6 proceeds to Step SP38, judges whether all topics have been processed or not, and when a negative result is obtained here, returns to Step SP 33 and processes a subsequent topic. On the other hand, an affirmative result is obtained in Step Sp38, the central processing unit 6 proceeds to Step SP39 and returns to the original processing procedure.

Accordingly, the central processing unit 6 forms an important keyword detection unit 48 (FIG. 3) detecting important keywords indicating the content of each topic in each topic.

Subsequently, the central processing unit 6 proceeds to Step SP41 (FIG. 1), executing index generation processing. The index generation processing is processing of generating indexes of respective topics. The central processing unit 6 generates an index from captions of the digest section of each topic by using important keywords detected in Step SP31.

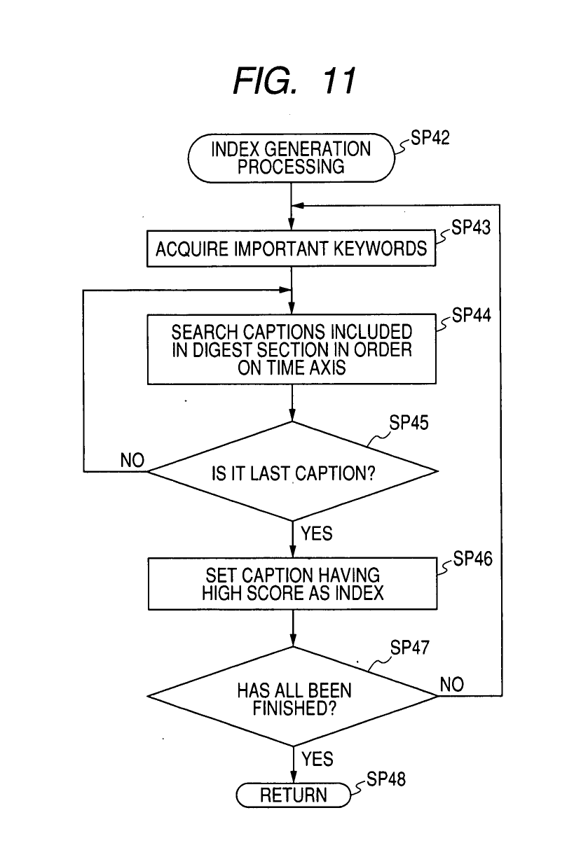

FIG. 11 is a flowchart showing index generation processing. The central processing unit 6, when starting the processing procedure, proceeds from Step Sp42 to Step SP43, selects one topic from captions provided by teletext broadcasting data. The central processing unit 6 acquires important keywords detected in Step SP31 with respect to the selected topic.

Subsequently, the central processing unit 6 proceeds to Step SP44, selects a segment of a sentence from the digest section of the selected topic, and detects important keywords detected in the topic from the segment of the sentence. The central processing unit 6 also adds scores of important keywords included in the segment of the sentence using scores of respective important keywords detected in the Step SP31 to calculate a score indicating importance of the segment. The segment of the sentence corresponds to character strings cut out from captions of the digest based on punctuation and the like so that the user can understand one meaning.

Subsequently, the central processing unit 6 proceeds to Step SP45, judges whether all segments of the selected topic has been processed or not, and when a negative result is obtained here, returns to Step SP44. Accordingly, the central processing unit 6 calculates scores showing the importance at each segment in the digest.

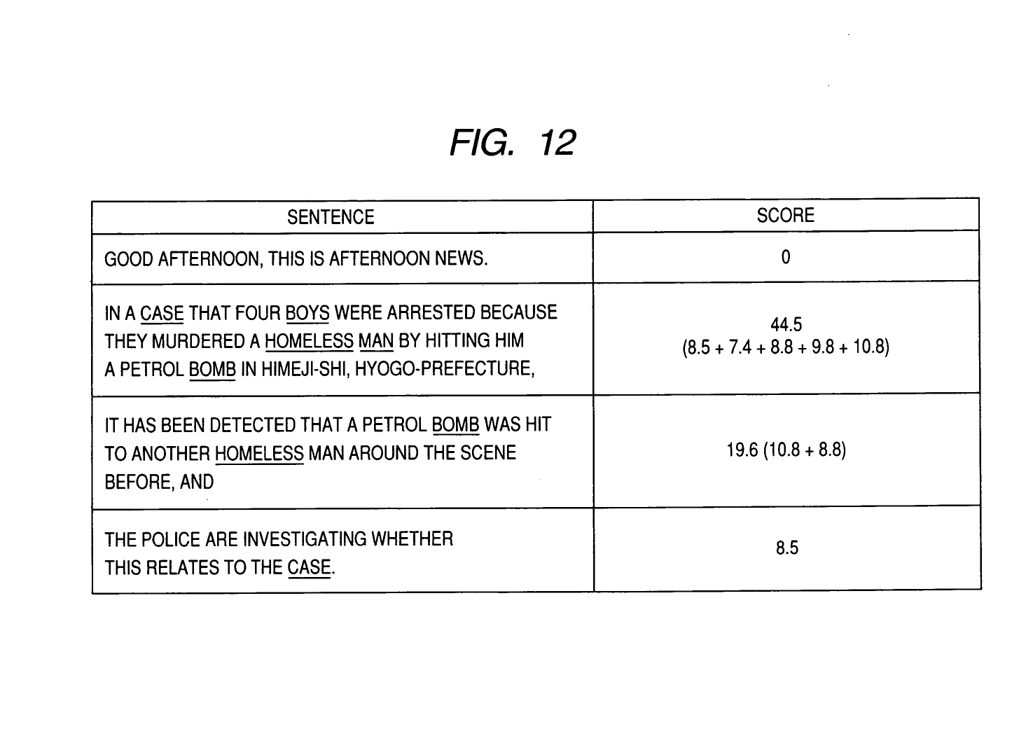

In the example of FIG. 10, keywords “bomb”, “man, “homeless”, “case” and “boy” are detected as important keywords, therefore, respective segments of sentences in the corresponding digest obtain scores of 0 point, 44.5 points, 19.6 points, and 8.5 points respectively as shown in FIG. 12.

The central processing unit 6 sets the segment of the sentence having the highest score as an index of the digest, and records it in the hard disc drive 32 with information specifying the corresponding topic and the digest section. In subsequent Step SP47, the central processing unit 6 judges whether all topics have been processed or not, and when a negative result is obtained here, proceeds to Step SP43 and processed a next topic. On the other hand, when an affirmative result is obtained here, the central processing unit 6 proceeds to Step SP48 and returns to the original processing procedure. When returning to the original processing procedure, the process proceeds from Step Sp41 to Step SP51 to end the processing of available time.

Accordingly, the central processing unit 6 forms an index generation unit 49 (FIG. 3) generating indexes of respective topics according to topics.

When the user instructs highlight playback by designating a video content recorded in the hard disc drive 32, the central processing unit 6 displays indexes of the video content.

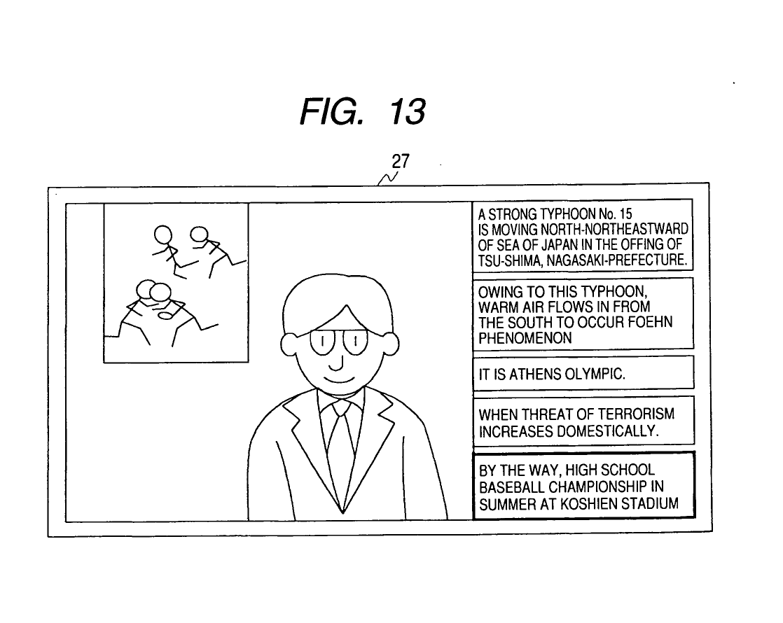

The central processing unit 6 displays a top frame of a digest section set as a top of the video content playback of which has been instructed by the user by a still image as shown in FIG. 13. The central processing unit 6 also displays indexes detected in respective topics in the video content sequentially. The display of indexes is scrolled in accordance with operation of the remote commander by the user. When the user instructs playback by selecting any one of index, a topic concerning the index selected by the user is played back and displayed.

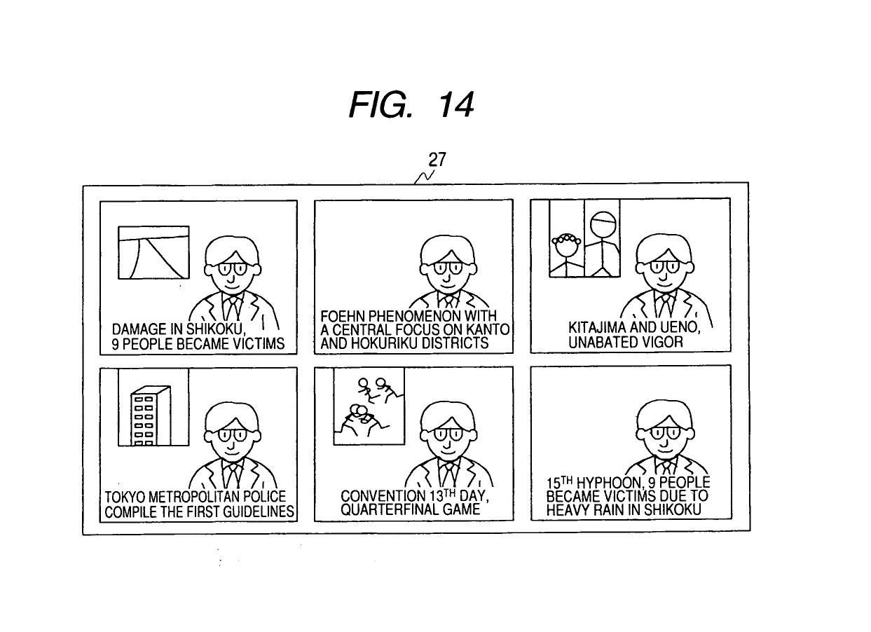

In this case, as shown in FIG. 14 as comparison of FIG. 13, it is preferable that thumbnail images of top frames of respective topics are displayed in a list and indexes are displayed at respective thumbnail images, and various displaying ways can be widely applied as the way of displaying indexes. It is also preferable that, instead of such display of top frames by still images, a video content is sequentially played back and displayed from the top, and indexes are displayed in a list at a part of display screen.

Accordingly, in the embodiment, the central processing unit 6 forms an index management unit 50 (FIG. 3) which manages indexes, and also forms an index display unit 51 which displays indexes together with the display controller 22 and the output unit 17.

### (2) Operation of the Embodiment

In the above configuration, concerning a program obtained from the internet 4 (FIG. 2), a transport stream is obtained from the Web server 5 through the modem 2 and the SIO controller, and the transport stream is separated into video data, audio data, teletext broadcasting data in the TS decoder 14. The video data, audio data, teletext broadcasting data are recorded in the hard disc drive 32 through the BUS. On the other hand, concerning a program of television broadcasting, broadcast waves received in the tuner 11 is processed and a transport stream is obtained, and the transform stream is separated into video data, audio data and teletext broadcasting data in the TS decoder 14. The video data, audio data and teletext broadcasting data are recorded in the hard disc drive 32 through the BUS.

In the hard disc recorder 1, when programs are recorded in the hard disc drive 32 in this manner, video data is decompressed in the AV decoder 19 and outputted to the BUS, which is analyzed in the central processing unit 6. Based on the analyzed result, feature amounts indicating continuity in continuous frames are detected and recorded in the hard disc drive 32 with video data and audio data (FIG. 4).

During available time after the completion of recording of the program, the feature amounts recorded in the hard disc drive 32 are processed and digest sections representing the contents of the program are detected (FIG. 1, FIG. 5 and FIG. 6). The digest sections detected in this manner are sections representing the contents of the program in pictures by video data, therefore, it is conceivable that captions allocated in the sections includes sentences representing the contents of the program. In actual, in news programs, first, an announcer explains a summary a piece of news, then, the detail of the content is introduced by showing pictures according to actual coverage. Therefore, a part explained by an announcer as the summary of the piece of news is detected as a digest section, and captions in the section include sentences explaining the summary of the piece of news.

However, when all captions in the digest sections are displayed, sentences to be displayed will be redundant, which makes difficult to grasp the summary of the program precisely. Also when thumbnail images of digest sections are displayed, it is difficult to grasp the summary of the program accurately and further, it is difficult to grasp the summary of the program precisely.

However, according to results of various analysis, keywords appeared in sentences of captions in the digest section also appear in parts other than the digest section. In addition, a sentence representing the content of the program most precisely in sentences of captions in the digest section includes important keywords most which appear in parts other than the digest section.

According to the above, in the hard disk recorder 1, important keywords whose appearance frequency is high are detected from caption of the program, and parts in which appearance frequency of the important keywords is high are detected from captions in the digest sections as indexes of the program, which is to be displayed (FIG. 1). Accordingly, in the hard disc recorder 1, it is possible to grasp the summary of the program more accurately and precisely as compared with related arts according to the display of indexes.

More specifically, captions in the program are sorted into captions in the digest section and captions in the section other than the digest section, setting higher score to captions of the side of the digest section (FIG. 7), and scores of respective keywords detected from captions of the program are calculated using the score, then, the predetermined number of keywords in order of score are selected to be set as important keywords (FIG. 8). In some programs, there are keywords which appear only in parts other than the digest sections. If such keywords are set as important keywords, it is difficult to create indexes from the digest sections correctly. In the hard disc recorder 1, a higher score is set to captions of the side of the digest section to select important keywords, as a result, keywords which appear only in parts other than the digest sections are not set as important keywords to efficiently avoid wrong setting of indexes.

Scores are set to captions so that, as a rate of the digest section occupied in the whole topic decreases, a score of the captions in the digest section increases as compared with a score of captions in the section other than the digest section. Accordingly, in the case that the length of the digest section and the length of the section other than the digest section change variously, important keywords can be appropriately detected without omission.

Specifically, in the hard disc recorder 1, scores are set to captions so that a value in which a score of captions in the digest section is divided by a score of captions of the section other than the digest section becomes a value in which the number of characters of captions in the section other than the digest section is divided by the number of characters of captions in the digest section. Accordingly, even in the case the length of the digest section and the length of the section other than the digest section change variously, important keywords can be appropriately detected without omission by simple processing.

Also, important keywords, indexes are detected in respective plural digest sections detected from one program, accordingly, for example, in a news program and the like, summaries of respective pieces of news can be grasped accurately as well as precisely.

### (3) Advantage of the Embodiment

According to the above configuration, digest sections representing the contents of the program are detected by analyzing video, and parts of captions in the digest sections including keywords whose appearance frequency is high detected in the whole captions are set as indexes, thereby grasping the summary of the program accurately and precisely.

In addition, captions in the program are sorted into captions of the digest section and captions of the section other than the digest section, setting a high score to captions in the side of digest section and important keywords are set by using the score. Accordingly, keywords which appear only in parts other than the digest sections are not set as important keywords to efficiently avoid wrong setting of indexes.

Scores are set to captions so that, as a rate of the digest section occupied in the whole topic decreases, a score of the captions in the digest section increases as compared with a score of the captions in the section other than the digest section. Accordingly, in the case that the length of the digest section and the length of the section other than the digest section change variously, important keywords can be appropriately detected without omission, and indexes can be created accurately.

More specifically, scores are set to captions so that a value in which a score of captions in the digest section is divided by a score of captions of the section other than the digest section becomes a value in which the number of characters of captions in the section other than the digest section is divided by the number of characters of captions in the digest section. Accordingly, even in the case the length of the digest section and the length of the section other than the digest section change variously, important keywords can be appropriately detected without omission by simple processing, and indexes can be created accurately. Also, important keywords, indexes are detected in respective plural digest sections detected from one program, accordingly, for example, in a news program and the like, summaries of respective pieces of news can be grasped accurately as well as precisely.

### Embodiment 2

In the above embodiment, the case in which scores of captions in the digest section and the section other than the digest section are set only by the rate of the number of characters has been described, however, the invention is not limited to the case. The method of setting scores can be changed variously if necessary such as a case in which scores are set to captions in the digest section and the section other than the digest section according to the rate of playback time, or a case in which scores of captions are changed in the digest section and the section other than the digest section according to the instruction of the length of the digest section creation by the user explained in FIG. 6.

In the above embodiment, the case in which thumbnail images of top frames of the top digest or respective topics are displayed with indexes has been described, however, the invention is not limited to this. It is also preferable that thumbnail images of the top frames of programs are displayed with indexes, and it is further preferable that only indexes are displayed.

In the above embodiment, the case in which character strings are cut out from captions of the digest based on punctuation and the like to a degree that the user grasps a meaning to create an index has been described, however, the invention is not limited to this, and it is also preferable that the length of the index is set in various ways as occasion demands.

In the above embodiment, the case in which captions of teletext broadcasting data are processed has been described, the invention is not limited to this, and it is also preferable to create captions from audio data by speech recognition processing to process the captions.

In the above embodiment, the case in which the embodiment of the invention is applied to a hard disc recorder and video contents are recorded and played back has been described, however, the invention is not limited to this and can be applied widely to such a case that, for example, a personal computer downloads news video to a personal terminal device. In this case, the summaries of respective pieces of news can be grasped precisely and accurately, therefore, it is possible to download and view news of interest precisely to a portable terminal device.

Also in the above embodiment, the case in which the embodiment of the invention is applied to the hard disc recorder has been described, however, the invention is not limited to this and the embodiment of the invention is widely applied to recording/playback devices for video contents using various recording media.

The embodiments of the invention can be applied to a hard disc recorder and the like which records and plays back video contents.

According to the embodiments of the invention, it is possible to grasp a summary of a program accurately and precisely.

It should be understood by those skilled in the art that various modifications, combinations, sub-combinations and alterations may occur depending on design requirements and other factors insofar as they are within the scope of the appended claims or the equivalents thereof.

What is claimed is:

1. A program providing method recording a program by video data and audio data in a recording medium and providing the program to a user, comprising the steps of:
detecting digest sections representing the contents of the program by video data by analyzing pictures of the video data;
detecting keywords whose appearance frequency is high from captions of the program;
creating indexes of the program by detecting parts where appearance frequency of the keywords detected in the step of detecting keywords is high from captions of the digest sections; and
displaying the indexes.

2. The program providing method according to claim 1,
wherein the step of detecting keywords includes the steps of
sorting captions of the program into captions in the digest section and captions in a section other than the digest section and setting a high score to captions of the side of the digest section,
detecting keywords from captions of the program and calculating scores of respective keywords by adding scores set in the step of sorting captions by each keyword, and
selecting the prescribed number of keywords in order of score calculated in the step of calculating scores to set the keywords.

3. The program providing method according to claim 2,
wherein the step of sorting captions sets scores so that, as a rate of the digest section occupied in the whole topic decreases, a score of captions in the digest section increases as compared with a score of captions in the section other than the digest section.

4. The program providing method according to claim 2,
wherein the step of sorting captions sets scores so that a value in which a score of captions in the digest section is divided by a score of captions of the section other than the digest section becomes a value in which the number of characters of captions of the section other than the digest section is divided by the number of characters of captions in the digest section.

5. The program providing method according to claim 1,
wherein the step of detecting digest sections detects plural digest sections from one program,
wherein the step of detecting keywords detects keywords from the digest section and from the subsequent section other than the digest section by each digest section detected in the step of detecting digest sections, and
wherein the step of creating indexes creates indexes by using corresponding keywords detected in the step of detecting keywords by each digest section.

6. The program providing method according to claim 1, further comprising the steps of:
receiving selection of indexes displayed in the step of displaying indexes; and
playing back the program from a position corresponding to an index selection of which has been received in the step of receiving selection.

7. A program for a program providing method recording a program by video data and audio data in a recording medium and providing the program to a user, comprising the steps of:
detecting digest sections representing the contents of the program by video data by analyzing pictures of the video data;
detecting keywords whose appearance frequency is high from captions of the program;
creating indexes of the program by detecting parts where appearance frequency of the keywords detected in the step of detecting keywords is high from captions of the digest sections; and
displaying the indexes.

8. A recording medium which records a program for a program providing method by recording a program by video data and audio data in a recording medium and providing the program to a user, the program providing method comprising the steps of:
detecting digest sections representing the contents of the program by video data by analyzing pictures of the video data;
detecting keywords whose appearance frequency is high from captions of the program;
creating indexes of the program by detecting parts where appearance frequency of the keywords detected in the step of detecting keywords is high from captions of the digest sections; and
displaying the indexes.

9. A program providing apparatus which records a program by video data and audio data in a recording medium and providing the program to a user, comprising:
a digest section detection unit detecting digest sections representing the contents of the program by video data by analyzing pictures of the video data;
a keyword detection unit detecting keywords whose appearance frequency is high from captions of the program;
an index creation unit creating indexes of the program by detecting parts where appearance frequency of the keywords detected in the keyword detection unit is high from captions of the digest sections; and
an index display unit displaying the indexes.
